(19) United States
(12) Patent Application Publication
(10) Pub. No.: US 2006/0262067 A1
(43) Pub. Date: Nov. 23, 2006

(54) Integrated chips and flat panel display device using the same

(75) Inventors: Yong Min Ha, Gyeongsangbuk-do (KR); Hong Soo Kim, Daegu (KR)

Correspondence Address: JENKENS & GILCHRIST, P.C., 901 15TH STREET N.W., SUITE 900, WASHINGTON, DC, 20005, US

(73) Assignee: LG.PHILIPS LCD CO., LTD., Seoul (KR)

(21) Appl. No.: 11/411,915

(22) Filed: Apr. 27, 2006

(30) Foreign Application Priority Data
Apr. 28, 2005 (KR) 10-2005-0035735

(51) Int. Cl. G09G 3/36

(52) U.S. Cl. 345/98

(57) ABSTRACT

An integrated circuit includes a first chip including a digital circuit for processing a digital signal; and a second chip including an analog circuit electrically connected to the digital circuit for processing the digital signal and outputting an analog signal having a voltage higher than a voltage of the digital signal, wherein the first and second chips are distinct from each other.

This application claims the benefit of the Korean Patent Application No. 2005-035735 filed on Apr. 28, 2005 which is hereby incorporated by reference.

### BACKGROUND OF THE INVENTION

1. Field of the Invention

The present invention relates to integrated circuits, and more particularly to integrated circuits for a flat panel display device.

2. Description of the Related Art

Generally, a liquid crystal display device displays an image by controlling the light transmittance of a liquid crystal layer by varying an applied electric field through the liquid crystal layer. To this end, the liquid crystal display device includes a liquid crystal display panel where liquid crystal cells are arranged in a matrix shape, and a drive circuit for driving the liquid crystal display panel.

FIG. 1 shows a liquid crystal display device according to the related art. Referring to FIG. 1, the liquid crystal display device includes a liquid crystal display panel 6 for displaying a picture; a data tape carrier package (TCP) 8 where a data driver integrated circuit (IC) 10 for driving data lines of the liquid crystal display panel 6 is mounted; a gate TCP 4 where a gate driver IC 12 for driving gate lines of the liquid crystal display panel 6 is mounted; and a timing controller 30 for driving the data driver IC 10 and the gate driver IC 12.

The liquid crystal display panel 6 includes a liquid crystal layer formed between an upper substrate 5 and a lower substrate 3, and a spacer for maintaining a fixed gap between the upper substrate 5 and the lower substrate 3. A color filter, a common electrode and a black matrix are formed in the upper substrate 5 of the liquid crystal display panel 6. The common electrode is formed in the upper substrate 5 or the lower substrate 3 of the liquid crystal display panel 6.

The lower substrate 3 of the liquid crystal display panel 6 includes a thin film transistor formed at each crossing of the gate lines and the data lines, and a liquid crystal cell electrically connected to the thin film transistor. A gate electrode of the thin film transistor (TFT) is electrically connected to one of the gate lines, a source electrode of the TFT is electrically connected one of the data lines, and a drain electrode of the TFT is electrically connected to a pixel electrode of the liquid crystal cell. The thin film transistor supplies a pixel signal from the data line to a pixel electrode of the liquid crystal cell in response to a scan signal from the gate line.

The liquid crystal cell includes a pixel electrode and a common electrode facing each other with a liquid crystal layer therebetween. The liquid crystal cell drives the liquid crystal layer in response to the pixel signal supplied to the pixel electrode, thereby controlling light transmittance of the liquid crystal layer.

The timing controller 30 generates a gate control signal (GSP, GSC, GOE, etc) which controls the driving of the gate driver IC 12, and generates a data control signal (SSP, SSC, SOE, POL, etc) which controls the driving of the data driver IC 10. Further, the timing controller 30 supplies a digital video data from a system to the data driver IC 10. The timing controller 30 is mounted on a data printed circuit board 20.

The data printed circuit board (PCB) 20 is electrically connected to an external system through a user connector. Signal lines are formed on the data PCB 20 for supplying various control signals and data signals from the timing controller 30 to the data driver IC 10 and the gate driver IC 12.

At least one gate driver IC 12 is mounted on the gate TCP 4. The gate driver IC 12 mounted on the gate TCP 4 is electrically connected to gate pads of the liquid crystal display panel 6 through the gate TCP 4. The gate driver IC 12 sequentially drives a corresponding gate line of the liquid crystal display panel 6 for one horizontal period (1H).

The gate TCP 4 is electrically connected to a gate printed circuit board 26. The gate PCB 26 supplies the gate control signals supplied from the timing controller 30 through the data printed circuit board 20 to the gate driver IC 12 through the gate TCP 4.

At least one data driver IC 10 is mounted on the data TCP 8. The data driver IC 10 mounted on the data TCP 8 is electrically connected to data pads of the liquid crystal display panel through the data TCP 8. The data driver IC 10 converts a digital video data into an analog gamma voltage and supplies the analog gamma voltage as a pixel voltage to a corresponding data line of the liquid crystal display panel 6.

FIG. 2 is a diagram representing a three-chip structure for a driving device of the related art liquid crystal display device. As shown in FIG. 2, the driver IC 50 has a three-chip structure composed of a data driver IC 52 for supplying a signal to the data line; a gate driver IC 54 for supplying a gate signal to the gate line; and a power driver IC 56 for generating and supplying a gate high/low voltage and an analog gamma reference voltage and a common voltage to the liquid crystal display panel.

FIG. 3 is a diagram representing a two-chip structure of a driving device of the related art liquid crystal display device. Referring to FIG. 3, the driver IC 60 has a two-chip structure including a data driver IC 62 and a gate power driver IC 64 into which the gate driver IC and the power driver IC are integrated into one chip.

FIG. 4 is a diagram representing a one-chip structure for a driving device of the related art liquid crystal display device. Referring to FIG. 4, the driver IC 70 has a one-chip structure where the data driver IC, the gate driver IC and the power driver IC are all integrated into one chip.

FIG. 5 is a diagram representing an internal structure of the driver IC shown in FIGS. 2 and 3. Referring to FIGS. 2, 3 and 5, each of the driver ICs 50 and 60 includes a digital block 80 having a timing controller 82 and a memory unit 84 to which the digital signal is supplied, and an analog block 90 having a digital-analog convertor 92 and a gamma voltage generator 94, which outputs an analog signal.

FIG. 6 is a diagram representing an internal structure of the driver IC 70 shown in FIG. 4. Referring to FIGS. 4 and 6, the driver IC 70 includes a digital block 100 having a timing controller 102 and a memory unit 104, and an analog block 110 having a digital-to-analog converter (DAC) 112, a gamma voltage generator 114, a common voltage generator 116, a level shifter 118 and a DC/DC converter 119.

A digital logic voltage processed in each of the digital blocks 80 and 100 has a voltage of 0V-3V, and a voltage processed in each of the analog blocks 90 and 110 has 20V-40V. Accordingly, a pitch between the signal lines in each of the digital blocks 80 and 100 is formed to be about 0.13 μm, and a pitch between the signal lines in each of the analog blocks 90 and 110 is formed relatively wider to be about 0.2 μm-0.3 μm. However, if each digital block 80 or 100 and the corresponding analog block 90 or 110 are formed concurrently, the signal line pitch is determined by the signal line pitch of the analog block 90 or 110. This is because noise might be introduced into the transmitted signal or heat might be generated or the signal lines might be damaged if the signal lines are as narrow as the signal line pitch of the one of digital blocks 80 and 100 and a relatively high analog voltage is supplied to the signal lines.

Thus, if one of the digital blocks 80 and 100 and the corresponding one of the analog blocks 90 and 110 are manufactured in one chip, product cost increases due to the increase in chip size and the decrease in yield especially since the pitch of the signal lines are determined on the basis of the maximum voltage processed in the analog blocks 90 and 110.

Moreover, the size of the memory unit and the timing operation change if the resolution of the liquid crystal display panel 6 is changed. Thus if one of the digital blocks 80 and 100 and the corresponding one of the analog blocks 90 and 110 are manufactured into one IC chip, the IC chip is special designed and depending on the liquid crystal display panel 6. As a result, the related art IC chip has a limited compatibility in a liquid crystal display panel of a different resolution.

### SUMMARY OF THE INVENTION

Accordingly, the present invention is directed to integrated chips and a flat panel display device using the same, which substantially obviate one or more problems due to limitations and disadvantages of the related art.

An object of the present invention to provide integrated circuits that provide an optimal chip size, and a flat panel display device using the same.

Another object of the present invention to provide integrated circuits that provide an optimal yield, and a flat panel display device using the same.

Another object of the present invention to provide integrated circuits that provide an improved compatibility, and a flat panel display device using the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages, an integrated circuit includes a first chip including a digital circuit for processing a digital signal; and a second chip including an analog circuit electrically connected to the digital circuit for processing the digital signal and outputting an analog signal having a voltage higher than a voltage of the digital signal, wherein the first and second chips are distinct from each other.

In another aspect, a flat panel display device includes a first chip including a digital IC for processing a digital signal; a second chip including an analog IC electrically connected to the digital IC for processing an analog signal having a voltage higher than a voltage of the digital signal; and a flat panel display panel displaying an image based on a signal from the analog IC, wherein the first and second chips are distinct from each other.

In another aspect, a flat panel display device includes a flat panel display panel; an analog IC mounted on a substrate of the flat panel display panel for outputting an analog data to the flat panel display panel; a signal transmission wiring film attached to the panel for transmitting a digital data to the flat panel display panel; and a digital IC mounted on the signal transmission wiring film, the digital IC for storing the digital data transmitted from the signal transmission wiring film and supplying the stored digital data to the analog IC, wherein a voltage of the analog data is higher than a voltage of the digital data.

In another aspect, a flat panel display device includes a flat panel display panel; a signal transmission wiring film attached to the panel for transmitting a digital data to the flat panel display panel; an analog IC mounted on a substrate of the flat panel display panel for outputting an analog data to the flat panel display panel; and a digital IC mounted on the substrate of the flat panel display panel for storing the digital data transmitted from the signal transmission wiring film and supplying the stored digital data to the analog IC through a signal line, wherein a voltage of the analog data is higher than a voltage of the digital data.

In another aspect, a flat panel display device includes a flat panel display panel; a signal transmission wiring film attached to the panel for transmitting a digital data to the flat panel display panel; an analog IC mounted on the signal transmission wiring film for outputting an analog data to the flat panel display panel; and a digital IC mounted on the signal transmission wiring film for storing the digital data transmitted from the signal transmission wiring film and supplying the stored digital data to the analog IC, wherein a voltage of the analog data is higher than a voltage of the digital data.

It is to be understood that both the foregoing general description and the following detailed description of the present invention are exemplary and explanatory and are intended to provide further explanation of the invention as claimed.

### BRIEF DESCRIPTION OF THE DRAWINGS

These and other objects of the invention will be apparent from the following detailed description of the embodiments of the present invention with reference to the accompanying drawings, in which:

FIG. 1 shows a liquid crystal display device according to the related art;

FIG. 2 is a diagram representing a three-chip structure for a driving device of the related art liquid crystal display device;

FIG. 3 is a diagram representing a two-chip structure of a driving device of the related art liquid crystal display device;

FIG. 4 is a diagram representing a one-chip structure for a driving device of the related art liquid crystal display device;

FIG. 5 is a diagram representing an internal structure of the driver IC shown in FIGS. 2 and 3;

FIG. 6 is a diagram representing an internal structure of the driver IC shown in FIG. 4;

FIG. 7 is a schematic diagram of an exemplary liquid crystal display device according to an embodiment of the present invention;

FIG. 8A is a block diagram representing an exemplary analog IC for the liquid crystal display device of FIG. 7 according to an embodiment of the present invention;

FIG. 8B is a block diagram representing an exemplary analog IC for the liquid crystal display device of FIG. 7 according to another embodiment of the present invention;

FIG. 9 a block diagram representing an exemplary digital IC for the liquid crystal display device of FIG. 7 according to an embodiment of the present invention;

FIG. 10 is a schematic diagram representing an exemplary packaging of an analog IC and a digital IC in a liquid crystal display device according to an embodiment of the present invention;

FIG. 11 is a schematic diagram representing another exemplary packaging of an analog IC and a digital IC in a liquid crystal display device according to another embodiment of the present invention; and

FIG. 12 is a schematic diagram representing another exemplary packaging of an analog IC and a digital IC in a liquid crystal display device according to another embodiment of the present invention.

FIG. 13 is a diagram showing an analog IC, a digital IC and a binding wiring between the analog IC and the digital IC in a flat panel display device according to another embodiment of the present invention.

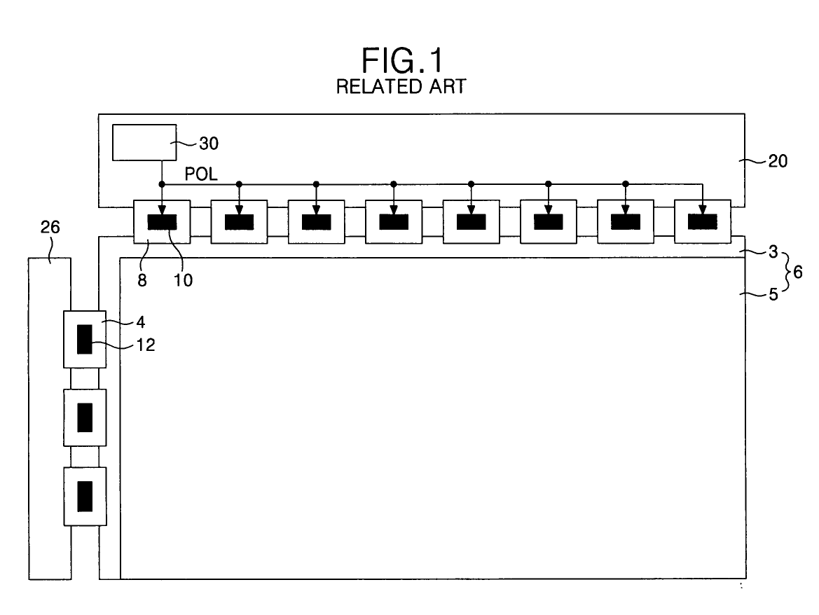

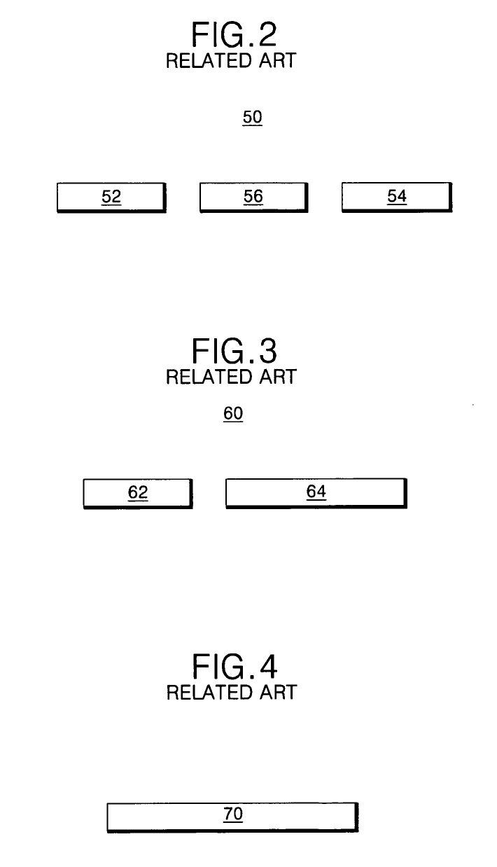

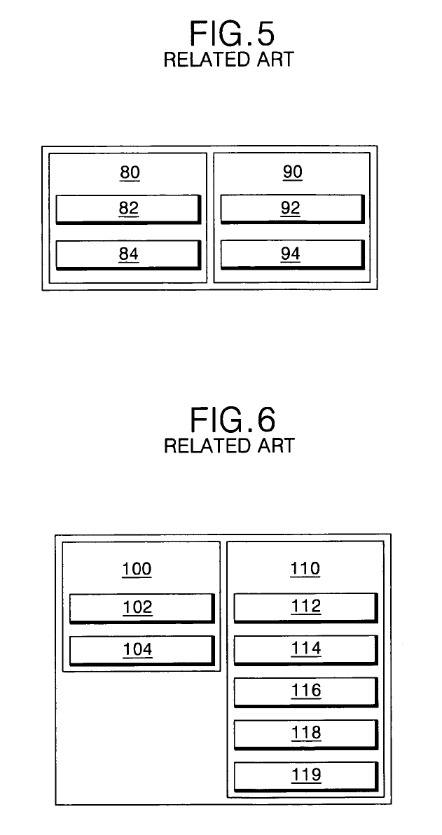

### DETAILED DESCRIPTION OF EXEMPLARY EMBODIMENTS

Reference will now be made in detail to the preferred embodiments of the present invention, examples of which are illustrated in the accompanying drawings.

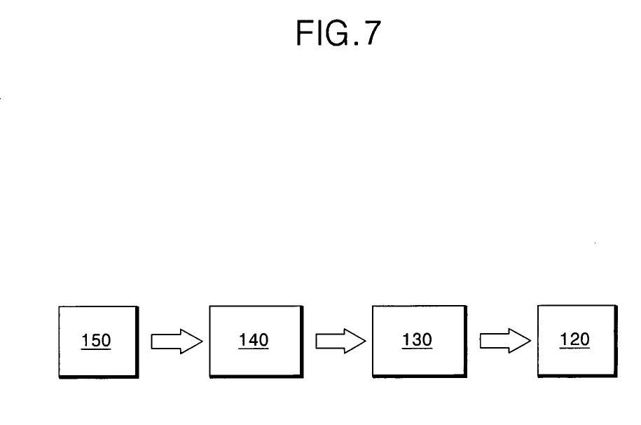

FIG. 7 is a schematic diagram of an exemplary liquid crystal display device according to an embodiment of the present invention. Referring to FIG. 7, a liquid crystal display device includes a liquid crystal display panel 120 for displaying a picture; an analog IC 130 for supplying an analog signal to the liquid crystal display panel 120; a digital IC 140 for supplying a signal to the analog IC 130; and a system 150 for supplying a signal to the digital IC 140. The system 150 includes an interface circuit for interfacing with an external device, a broadcast receiving circuit, an analog-to-digital converter, a graphic processing circuit, and a scheduler circuit. The system 150 converts an externally provided data, for example, a broadcasting data, from the external device into a digital data. The converted digital data is signal-interpolated and processed for graphic. Then, the processed digital data is supplied to the digital IC 140. Further, the system 150 extracts a vertical/horizontal synchronization signal from the externally provided data from the external device, and generates control signals, such as synchronization signals, clock signals and data enable signals.

The digital IC 140 stores the processed data from the system 150 at a location in a memory unit and supplies the stored data to the analog IC 130. Also, the digital IC 140 is controlled by the control signal from the system 150 and supplies the control signal to the analog IC 130.

The analog IC 130 converts the digital data received from the digital IC 140 into an analog data with an analog gamma voltage. Then, the analog IC 130 supplies the analog data to the data lines of the liquid crystal display panel 120. Further, the analog IC 130 generates panel drive voltages, such as analog gamma voltages, a common voltage, and a gate high/low voltage. The analog gamma voltages are supplied to a digital-to-analog converter, and a common voltage is supplied to the common electrode of the liquid crystal display panel 120. Moreover, the gate high/low voltage is a swing voltage of a gate pulse (or scan pulse) and is supplied to the gate lines of the liquid crystal display panel 120. The analog IC 130 can include a sample-and-hold circuit for sampling the analog data and/or holding the sampled analog data.

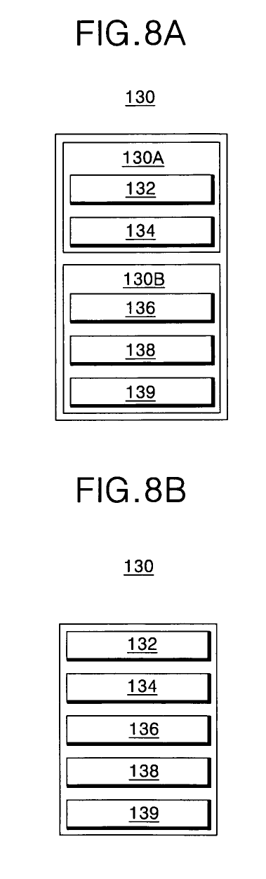

FIG. 8A is a block diagram representing an exemplary analog IC for the liquid crystal display device of FIG. 7 according to an embodiment of the present invention. Referring to FIG. 8A, the analog IC 130 includes a first analog IC 130A and a second analog IC 130B. In particular, the analog IC 130 is fabricated in a separate fabricating process from the fabricating process of the digital IC 140.

The first analog IC 130A includes a digital-to-analog converter 132 and a gamma voltage generator 134. The gamma voltage generator 134 generates an analog gamma voltage and supplies the analog gamma voltage to the digital-to-analog converter 132. The digital-to-analog converter 132 converts a digital video data based on the analog gamma voltage to supply a signal to the data line.

The second analog IC 130B includes a common voltage generator 136, a level shifter 138 and a DC/DC converter 139. The DC/DC converter 139 generates the gate high/low voltage and a gamma reference voltage to be supplied to the gamma voltage generator 134. The common voltage generator 136 generates a common voltage supplied to the common electrode of the liquid crystal panel 120 (shown in FIG. 7). The level shifter 138 shifts a voltage level of the gate high/low voltage to adjust a swing width of the gate pulse (or scan pulse) to fit a thin film transistor characteristic of the liquid crystal display panel 120 (shown in FIG. 7).

FIG. 8B is a block diagram representing an exemplary analog IC for the liquid crystal display device of FIG. 7 according to another embodiment of the present invention. Referring to FIG. 8B, the analog IC 130 is fabricated as a single chip including all of a digital-to-analog converter 132, a gamma voltage generator 134, a common voltage generator 136, a level shifter 138 and a DC/DC converter 139. Moreover, the analog IC 130 is fabricated in a separate fabricating process from the fabricating process of the digital IC 140.

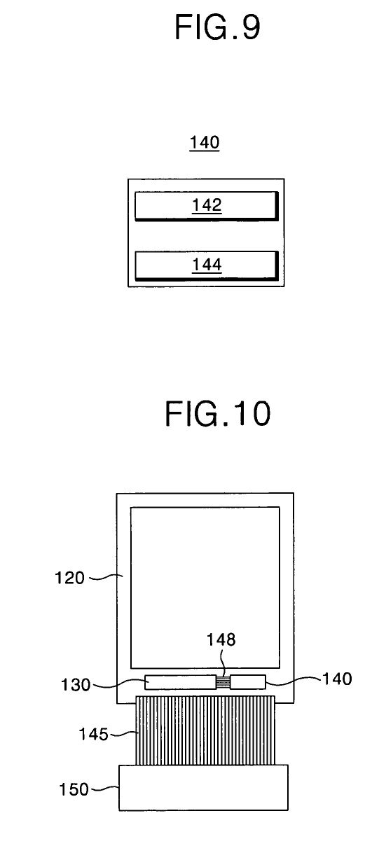

FIG. 9 is a block diagram representing an exemplary digital IC for the liquid crystal display device of FIG. 7 according to an embodiment of the present invention. Referring to FIG. 9, the digital IC 140 includes a timing controller 142 and a memory unit 144. The digital IC 140 is fabricated in a separate fabricating process from the fabricating process of the analog IC 130.

The digital IC 140 can include, for example, a digital image processor for processing still image data. The still image data processed by the digital image processor in the digital IC 140 may be images captured by and/or transmitted from a digital still camera. The images can either be raw images or JPEG compressed images.

The digital IC 140 can also include a digital video processor for processing moving images, moving pictures, or motion video data, such as MPEG video data.

The digital IC 140 can further include a digital signal processor for performing error correction, error diffusion, dithering, frame rate control, up-conversion, down-conversion, signal interpolation, anti-aliasing on the image or video data.

The digital IC 140 may include a shift register for performing a shifting of a digital data. The digital IC 140 may also include a latch for latching the digital data.

According to an embodiment of the present invention, the analog IC 130 and the digital IC 140 in the liquid crystal display device are fabricated in separate fabricating processes. As a result, the pitch of the signal lines is optimally designed for a processed voltage. Moreover, only the digital IC 140 is replaced in accordance with resolution, thereby improving compatibility.

In other words, the digital IC 140 has a signal line of about 0.13 μm for a digital logic voltage of about 0V-3.3V. Thus, the chip size and yield are optimized. The pitch of the signal lines in the digital IC 140 is minimized irrespective of the analog IC 130. Thus it is possible to realize a high-density memory unit corresponding to high resolution while maintaining a small chip size.

The quantity and voltage of the processed data from the analog IC 130 varies in accordance with the size and resolution of the liquid crystal display panel 120. Thus, the pitch of the optimal signal line is designed and fabricated in accordance with the liquid crystal display panel 120. The analog IC 130 is fabricated in a different fabricating process from the digital IC 140. Thus, the chip size and yield are optimized in accordance with the liquid crystal display panel 120 irrespective of the digital IC 140.

FIG. 10 is a schematic diagram representing an exemplary packaging of an analog IC and a digital IC in a liquid crystal display device according to an embodiment of the present invention. Referring to FIG. 10, the analog IC 130 and the digital IC 140 are mounted on a glass substrate of the liquid crystal display panel 120 by a chip-on-glass (COG) process. The system 150 is electrically connected to the digital IC 130 through a signal transmission wiring film 145 attached to the liquid crystal display panel 120. The signal transmission wiring film 145 may include a flexible printed circuit (FPC). A signal line 148 is formed on a glass substrate for signal transmission between the digital IC 140 and the analog IC 130. The signal line 148 between the digital IC 140 and the analog IC 130 can be simultaneously formed by a line-on-glass (LOG) process with the data line or the gate line of the liquid crystal display panel 120.

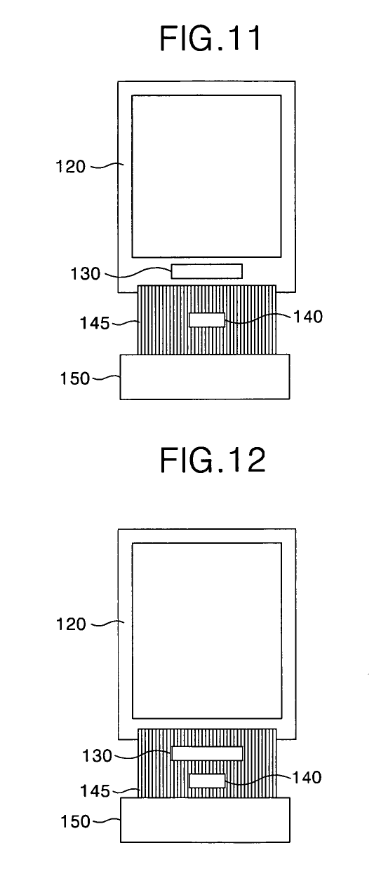

FIG. 11 is a schematic diagram representing an exemplary packaging of an analog IC and a digital IC in a liquid crystal display device according to another embodiment of the present invention. Referring to FIG. 11, the analog IC 130 is mounted on the glass substrate of the liquid crystal display panel 120 by a COG process. The digital IC 140 is mounted on the signal transmission wiring film 145 through a chip-on-film (COF) process. Thus, the digital IC 140 is electrically connected to the analog IC 130 through the signal transmission wiring film 145. An input terminal of the digital IC 140 mounted on the signal transmission wiring film 145 through the COF process may be electrically connected to an output pad of a PCB of the system 150 through the signal transmission wiring film 145. Similarly, an output terminal of the digital IC 140 may be electrically connected to an input pad of the liquid crystal display panel 120 through the digital IC 140 mounted on the signal transmission wiring film 145.

FIG. 12 is a schematic diagram representing an exemplary packaging of an analog IC and a digital IC in a liquid crystal display device according to another embodiment of the present invention. Referring to FIG. 12, the digital IC 140 and the analog IC 130 are both mounted on the signal transmission film 145 through a COF process. The input terminal of the COF may be electrically connected to the PCB of the system 150, and the output terminal of the COF may be electrically connected to the input pad of the liquid crystal display panel 120.

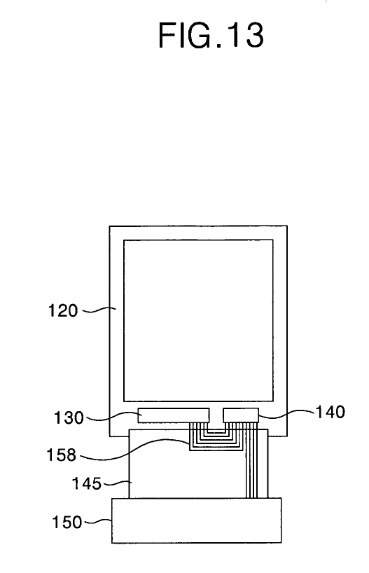

FIG. 13 is a diagram showing an analog IC, a digital IC and a binding wiring between the analog IC and the digital IC in a flat panel display device according to another embodiment of the present invention. Referring to FIG. 13, the analog IC 130 and the digital IC 140 are directly mounted on the glass substrate of the liquid crystal display panel 120 through a COG process. The system 150 is connected to the digital IC 130 through the signal transmission wiring film 145 attached to the liquid crystal display panel 120. The signal transmission wiring film 145 can be, for example, a FPC. A binding wiring 158 is formed on the signal transmission wiring film 145 for electrically connecting the output pad of the digital IC 140 and the input pad of the analog IC 130 and transmitting signals between the digital IC 140 and the analog IC 130.

In other embodiments of the present invention, the display device includes a Flat Panel Display including an OLED, FED (Field EMISSION display), e-ink, PDP (Plasma Display Panel), Flexible Display, thin CRT (cathode ray tube).

In accordance with embodiments of the present invention, the digital IC and the analog IC for the liquid crystal device are fabricated through independent fabricating processes. Thus, the area and yield of the integrated circuit fabrication process are optimized. Further, the digital IC is used to implement a large memory unit on a small chip. Moreover, the analog IC is optimized in accordance with the size and resolution of the liquid crystal display panel and is connected to the digital IC which is fabricated in the same specification, thereby increasing compatibility.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. An integrated circuit, comprising:
a first chip including a digital circuit for processing a digital signal; and
a second chip including an analog circuit electrically connected to the digital circuit for processing the digital signal and outputting an analog signal having a voltage higher than a voltage of the digital signal,
wherein the first and second chips are distinct from each other.

2. The integrated circuit according to claim 1, wherein the digital circuit includes at least one of a timing controller, a memory unit, a digital image processor, a digital video processor, a digital signal processor, a shift register, and a latch.

3. The integrated circuit according to claim 1, wherein the analog circuit includes at least one of a digital-to-analog converter, a common voltage generator, a DC/DC converter, a gamma voltage generator, an analog sample-and-holder, and a level shifter.

4. The integrated circuit according to claim 1, wherein a pitch of signal lines in the digital circuit is narrower than a pitch of signal lines in the analog circuit.

5. A flat panel display device, comprising:
a first chip including a digital IC for processing a digital signal;
a second chip including an analog IC electrically connected to the digital IC for processing an analog signal having a voltage higher than a voltage of the digital signal; and
a flat panel display panel displaying an image based on a signal from the analog IC, wherein the first and second chips are distinct from each other.

6. The flat panel display device according to claim 5, wherein the digital circuit includes at least one of a timing controller, a memory unit, a digital image processor, a digital video processor, a digital signal processor, a shift register, and a latch.

7. The flat panel display device according to claim 5, wherein the analog circuit includes at least one of a digital-to-analog converter, a common voltage generator, a DC/DC converter, a gamma voltage generator, an analog sample-and-holder, and a level shifter.

8. The flat panel display device according to claim 5, wherein the analog IC and the digital IC are mounted on a substrate of the flat panel display panel.

9. The flat panel display device according to claim 8, wherein signal lines between the digital IC and the analog IC are formed on the substrate of the flat panel display panel.

10. The flat panel display device according to claim 8, further comprising a signal transmission wiring film attached to the panel and a signal line electrically connecting the digital IC to the analog IC through the signal transmission wiring film.

11. The flat panel display device according to claim 10, further comprising a system for supplying a signal to the digital IC through the signal transmission wiring film.

12. The flat panel display device according to claim 5, further comprising a signal transmission wiring film attached to a substrate of the flat panel display panel and electrically connected to the analog IC, wherein the digital IC is mounted on the signal transmission wiring film, and the analog IC is mounted on the substrate of the flat panel display panel.

13. The flat panel display device according to claim 12, further comprising a system for supplying a signal to the digital IC through the signal transmission wiring film.

14. The flat panel display device according to claim 5, further comprising a signal transmission wiring film attached to a substrate of the flat panel display panel, wherein the analog IC and the digital IC are mounted on the signal transmission wiring film.

15. The flat panel display device according to claim 13, further comprising a system for supplying a signal to the digital IC through the signal transmission wiring film.

16. The flat panel display device according to claim 5, wherein a pitch of signal lines in the digital IC is narrower than a pitch of signal lines in the analog IC.

17. A flat panel display device, comprising:
a flat panel display panel;
an analog IC mounted on a substrate of the flat panel display panel for outputting an analog data to the flat panel display panel;
a signal transmission wiring film attached to the panel for transmitting a digital data to the flat panel display panel; and
a digital IC mounted on the signal transmission wiring film, the digital IC for storing the digital data transmitted from the signal transmission wiring film and supplying the stored digital data to the analog IC, wherein a voltage of the analog data is higher than a voltage of the digital data.

18. The flat panel display device according to claim 17, wherein a pitch of signal lines in the digital IC is lower than a pitch of signal lines in the analog IC.

19. A flat panel display device, comprising:
a flat panel display panel;
a signal transmission wiring film attached to the panel for transmitting a digital data to the flat panel display panel;
an analog IC mounted on a substrate of the flat panel display panel for outputting an analog data to the flat panel display panel; and
a digital IC mounted on the substrate of the flat panel display panel for storing the digital data transmitted from the signal transmission wiring film and supplying the stored digital data to the analog IC through a signal line, wherein a voltage of the analog data is higher than a voltage of the digital data.

20. The flat panel display device according to claim 19, wherein a pitch of signal lines in the digital IC is narrower than a pitch of signal lines in the analog IC.

21. A flat panel display device, comprising:
a flat panel display panel;
a signal transmission wiring film attached to the panel for transmitting a digital data to the flat panel display panel;
an analog IC mounted on the signal transmission wiring film for outputting an analog data to the flat panel display panel; and
a digital IC mounted on the signal transmission wiring film for storing the digital data transmitted from the signal transmission wiring film and supplying the stored digital data to the analog IC, wherein a voltage of the analog data is higher than a voltage of the digital data.

22. The flat panel display device according to claim 21, wherein a pitch of signal lines in the digital IC is narrower than a pitch of signal lines in the analog IC.
